(19) United States
(12) Patent Application Publication
(10) Pub. No.: US 2011/0120353 A1
(43) Pub. Date: May 26, 2011

(54) PLASTIC RACKABLE PALLET

(76) Inventors: Guy Jensen, Bradington, FL (US); Terry L. Ingham, Oxford, MI (US)

(21) Appl. No.: 12/888,000

(22) Filed: Sep. 22, 2010

Related U.S. Application Data
(60) Provisional application No. 61/244,556, filed on Sep. 22, 2009.

(51) Int. Cl. B65D 19/38; B29C 65/06

(52) U.S. Cl. 108/57.25; 156/73.5

(57) ABSTRACT

A rackable pallet having an upper deck, a lower deck, and a center frame connecting the upper and lower decks together to form a rackable pallet. At least one of the upper deck, lower deck, and center frame comprises a structural foam molded thermoplastic resin material. A reinforcement support structure may be disposed between the center frame and lower deck.

### CROSS-REFERENCE TO RELATED APPLICATIONS

This application claims the benefit of U.S. Provisional Application No. 61/244,556 filed on Sep. 22, 2009. The disclosure of the above application is herein incorporated by reference.

### FIELD

The present disclosure relates to a pallet, and more particularly, a plastic rackable pallet.

### BACKGROUND

The statements in this section merely provide background information related to the present disclosure and may not constitute prior art.

The common wooden and plastic industrial pallets have several shortcomings in regard to cost, quality, limitations of their use, and ease of manufacture. Wooden pallets are typically constructed by sandwiching wooden block members between two similar decks or surfaces. Since the aesthetic appearance of pallets may not outweigh the cost, they may often include scrap or recycled wood. The surfaces may be made of a continuous sheet or have a plurality of wooden boards typically arranged in a parallel manner.

By its nature, ordinary wood may be subject to swelling, warping, shrinkage, splintering, deterioration, and fungal or bacterial growth after exposure to moisture and other elements. Pallets assembled with inferior quality wood blocks and/or boards may lead to potential cargo damage. Attempts to overcome the drawbacks of ordinary wooden pallets with plastic pallets have been faced with similar shortcomings. Prior designs of plastic pallets have had to deal with issues such as the trade off between cost and weight bearing capability. Typically, plastic pallets designed with a significant weight bearing capability have tended to be both heavy and expensive. In the same manner, inexpensive plastic pallets have had both strength and durability issues.

In recent times, society has expended significant efforts on continuing the development of more environmentally-friendly methods for reusing various synthetic and plastic materials. It is therefore desirable to provide a long-life pallet having outstanding physical attributes that is relatively inexpensive and can be manufactured with relative ease. Specifically, it is desirable to provide a low cost pallet that meets and exceeds stringent strength and design standards while being configured to be easily stacked and rackable during periods of non-use and transportation.

### SUMMARY

This section provides a general summary of the disclosure, and is not a comprehensive disclosure of its full scope or all of its features.

The present disclosure provides a rackable pallet having an upper deck, a lower deck, and a center frame connecting the upper and lower decks together to form a rackable, stackable pallet. At least one of the upper deck, lower deck, and center frame comprises a structural foam molded thermoplastic resin material. The center frame may include a plurality of spacer members separating the upper deck and lower deck and defining a plurality of apertures therebetween. In certain embodiments, a reinforcement support structure may be disposed between the center frame and lower deck.

The present disclosure also provides a method for manufacturing a rackable pallet. The method includes forming an upper deck, a lower deck, and center frame from a structural foam molded thermoplastic resin. The lower deck is joined to the center frame, which is joined to the upper deck to form a rackable pallet. In various embodiments, the method includes providing a reinforcement support structure disposed between the center frame and lower deck. The method includes forming the structural molded thermoplastic resin components with a resin selected from the group consisting of HDPE, ABS, PPO, PPE, nylon, and resin mixtures thereof, with a foaming agent.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a top perspective view of an exemplary pallet in accordance with teachings of the present disclosure;

FIG. 2 is an exploded perspective view of FIG. 1;

FIG. 3 is a bottom perspective view of the pallet of FIG. 1;

FIG. 4 is an exploded perspective view of FIG. 3;

FIG. 5 is a cross-sectional view of the pallet of FIG. 1 taken along the line 5-5; and

FIG. 6 is a partial cross-sectional view of the pallet of FIG. 1 taken along the line 6-6.

It should be noted that the figures set forth herein are intended to exemplify the general characteristics of an apparatus, materials, and methods among those of this disclosure, for the purpose of the description of such embodiments herein. These figures may not precisely reflect the characteristics of any given embodiment, and are not necessarily intended to define or limit specific embodiments within the scope of this disclosure.

### DETAILED DESCRIPTION

The following description of the present disclosure is merely exemplary in nature and is in no way intended to limit the disclosure, its application, or uses. For purposes of clarity, it should be understood that throughout the drawings, corresponding reference numerals indicate like or corresponding parts and features. Example embodiments will now be described more fully with reference to the accompanying drawings.

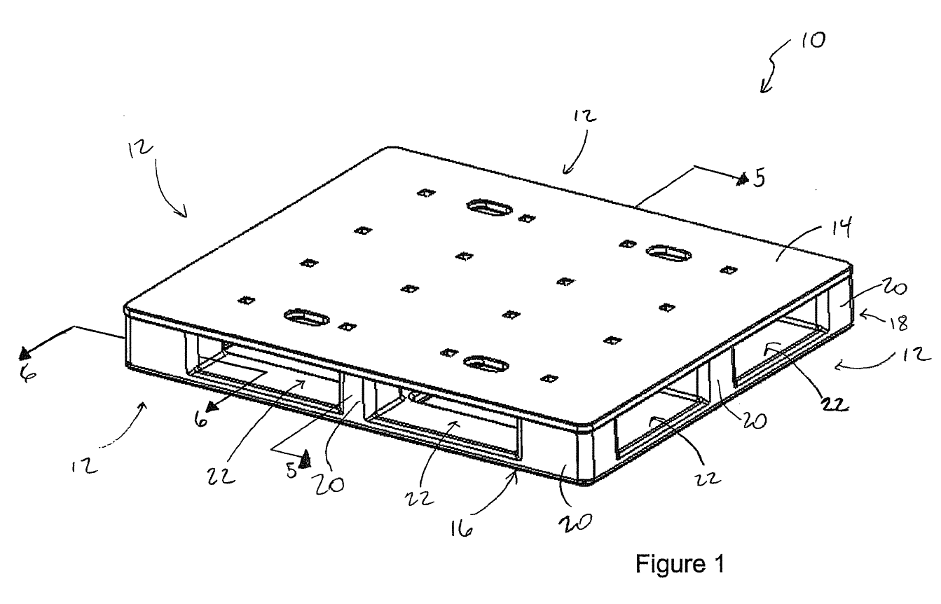

As shown in FIGS. 1 through 4, and generally referenced by the number 10, the pallet of the present disclosure has four peripheral sides 12, or edges, defining a perimeter. Preferably each side 12 is disposed at a substantially right angle, thereby forming a generally square or rectangular shape. In one embodiment, the pallet 10 can be constructed having the industry standard size and dimensions, which is currently 40 inches wide by 48 inches long (1.0 m by 1.2 m), although it may be made in any desired size or shape. The pallet 10 includes an upper deck 14, a lower deck 16, and a center frame 18 connecting the upper deck 14 to the lower deck 16. According to the principles of the present disclosure, at least one of the upper deck 14, the lower deck 16, and the center frame 18 may comprise a structural foam molded thermoplastic resin, as will be discussed in more detail below. Once assembled, the upper and lower decks 14, 16 are held together via the center frame 18 having a plurality of support members, generally referenced by the number 20. The layers, or components, of the pallet 10 may be fastened, secured, or bonded together mechanically or preferably using welding or fusing techniques for use with plastic and resin components as known in the art. A rackable pallet of the present disclosure also has the capability of being fitted with RFID technology. For example, each side 12 or corner area of the pallet 10 can be provided with an RFID tag, allowing ease of tracking.

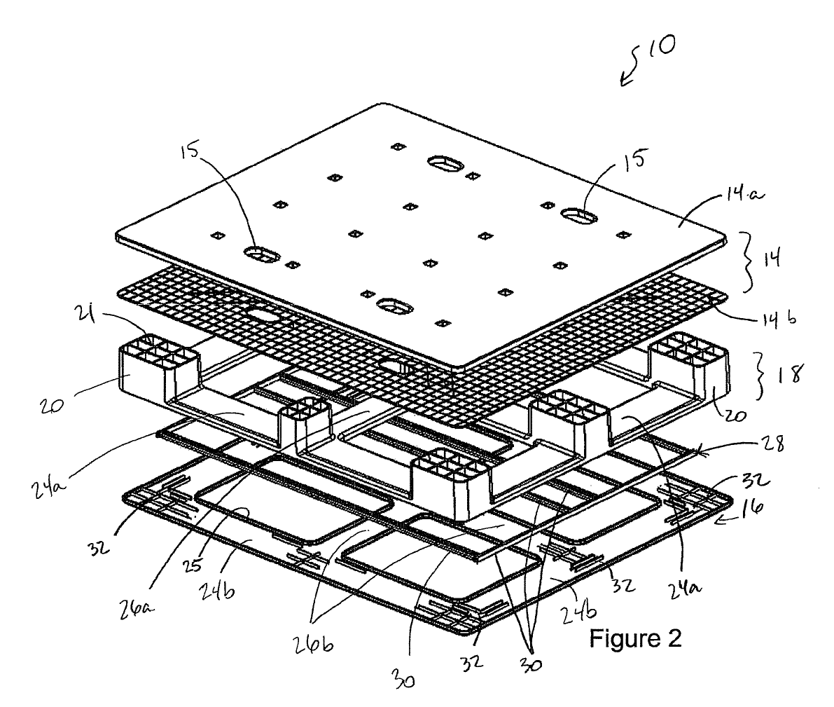

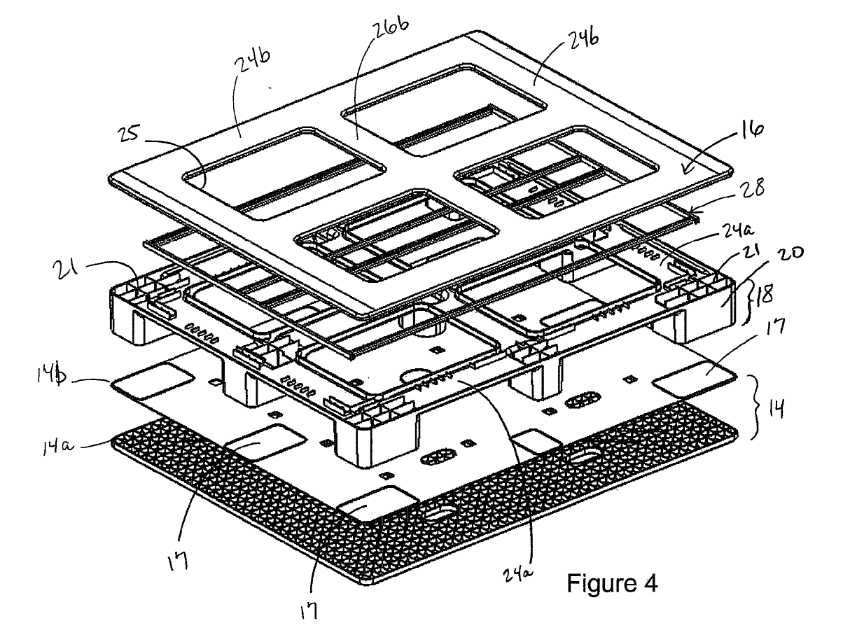

FIG. 1 is a top perspective view of an exemplary pallet in accordance with teachings of the present disclosure. FIG. 2 provides a top exploded perspective view of the pallet of FIG. 1, showing various details of the components. The upper deck 14 may be a single component, or may include two sheets of material 14a, 14b joined together. For example, the upper deck 14 may be formed as a structural foam enclosed member. This provides a double sided, hollow upper deck 14 with the option of having various features or geometries on one or both sides of the exterior. For example, as best shown in FIG. 4, the underside 14b of the upper deck 14 may include indentations 17 configured to correspond or mate with the spacer members 20 of the center frame 18. The interior of the structural foam molded plastic sheets 14a, 14b may be provided with a reinforcement webbing design having integral ribs and channels for additional support and strength. Such a structural foam molded upper deck 14 provides a strong, yet lightweight and seamless component.

In various embodiments, the upper deck 14 defines a generally planar load bearing surface upon which objects and goods may be positioned for transport and storage. In certain embodiments, the upper deck 14 can have the shape of a continuous sheet of material. A number of indentations and projections such as ridges and channels may be formed therein to allow for the drainage of any liquids that may accumulate thereon. Alternate embodiments may include further channels configured to direct fluid to the sides of the pallet if necessary. Handles 15 may also be provided for ease in moving or carrying the pallet 10. As should be understood, the number, orientation, size and shape of any ridges, channels, indentations, projections, handles, etc. can be varied in many alternate configurations for optimized strength and purpose of use.

The load bearing surface may have a texture or an etched or imprinted geometrical pattern thereon (not shown) that acts as a non-skid surface to prevent objects from sliding during transport. Alternatively, any suitable type of friction tape or friction coating may be applied or laminated to the load bearing surface in order to help prevent movement of objects on the pallet. The final pallet assembly may additionally be embossed, silk screened, painted, laser etched, or printed with indicia such as graphics, text, codes, brands, or the like if so desired.

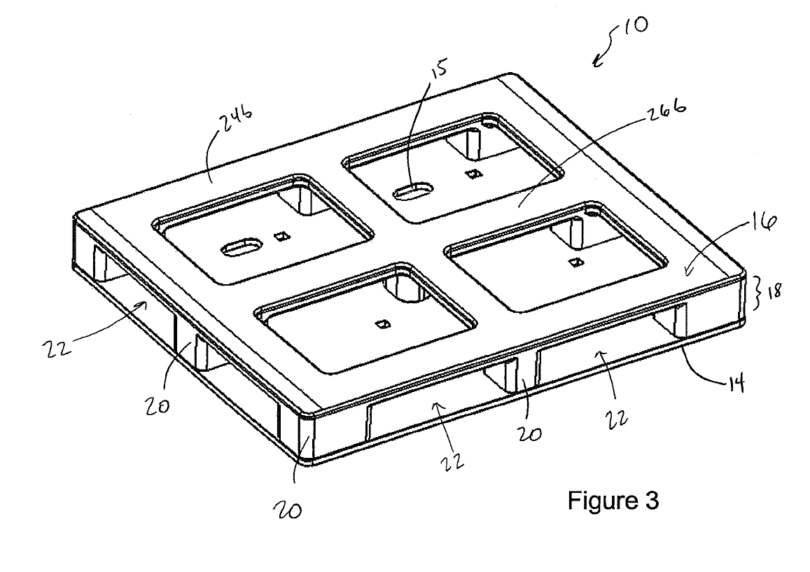

FIG. 3 illustrates a bottom perspective view of the pallet of FIG. 1, and FIG. 4 is bottom exploded perspective view of the pallet of as shown in FIG. 3. The lower deck 16 defines a substantially planar bottom surface for the secure placement of the pallet on the ground or other resting surface. This also allows for the stable stacking of the pallet onto a similarly designed pallet.

As shown, the center frame 18 is a monolithic member that may be formed via structural foam molding and provided with a plurality of support members, or blocks 20, that separate and hold the upper and lower decks 14, 16 together, while bearing and distributing the cargo loads placed on the upper deck 14. Preferably, there are nine support members 20, aligned in three rows of three, defining two apertures 22 on each side 12 of the pallet 10. Ideally, each pallet has four corner blocks, four mid-side blocks, and one center block member. The size of the apertures 22 will depend upon the size and length of the support members 20. The support members 20 may be provided with various sizes and shapes and need not all be the same size or shape. In certain embodiments and as shown, the center frame 18 is provided with various longitudinally and laterally extending cross board members that connect the support members 20 to one another. Such cross board members are aligned and connected to form a substantially rectangular or square shaped outer frame similar to that of the upper deck 14. Additional cross-members may be used, depending upon the desired load capacity of the pallet 10. As shown, the center frame 18 includes four outer perimeter cross board members 24a and at least one center cross board member 26a. Such a geometry shown with two perpendicular center cross board members 26a defines four apertures 25. The lower deck 16 has substantially the same footprint as the center frame 18 and is shown provided with four outer perimeter cross board members 24b and two center cross board members 26b to mate with those of the center frame 18. The various cross board members 24a, 24b, 26a, 26b of the center frame 18 and of the lower deck 16 may have dimensions of between about 3½ to about 5½ inches in width, and may vary in length such that the total width and length of the pallet is about 40 by 48 inches, respectively. For rackable pallets, it may be preferred to have a width and length of 48 by 48 inches.

In various embodiments, the separate structural foam molded pallet components may be joined to one another via vibration welding, infrared welding, hot plate welding, and other welding or fusing techniques. Vibration welding presently provides various benefits in regard to the speed of the welding and the ability to fuse more rib members of adjacent components to one another. With vibration welding, for example, one component is held in a fixed or stationary position while the adjacent component is provided with vibrational movement, such as high frequency oscillation. When the upper deck components 14a, 14b are joined by vibration welding techniques, preferably each and every respective rib member of the adjacent components, for example of upper deck components 14a, 14b, is fused together yielding an exceptional weld. Other joining methods, such as twin sheet thermoforming, may only provide for the opportunity of about 10% touch points, where the respective ribs are fused together. The present invention provides up to a ten-fold increase in the amount of fused ribs, providing exceptional strength. For the fusing and welding processes described above, the ribs in direction of weld may be provided with a minimum thickness of about 2 mm, and the ribs perpendicular to the direction of weld may be provided with a minimum thickness of about 3 mm at the bonding surface. In addition, a unique 1 inch grid pattern of the bonding ribs may be provided on the upper deck component 14a that increases the bonding surface, which, in effect, increases the dynamic, static, and rack load. With infrared welding or hot plate welding, the two sheets 14a, 14b may be bonded together while they are still hot or may be separately heated to provide the manufacture of a hollow finished piece 14.

Preferably, the spacer members 20 are of a sufficient size so that the apertures 22 between them define a space suitable for access by the tines, or forks, of a forklift truck or pallet jack from any of the four sides 12 of the pallet 10. The size and number of apertures 22 will depend upon the placement and number of spacer members 20 and cross board members 24a, 24b, 26a, 26b used, and may be driven by the overall pallet size and load requirements. The current industry standard is to have apertures 22 with a separation distance of about 3.5 inches between the upper deck 14 and lower deck 16. For additional impact resistance, the spacer members 20 may be provided with slightly rounded or curved ends, thereby minimizing potential damage which may occur upon collision or brunt contact. Depending upon the specific resin material and desired strength, the spacer members 20 may be formed with a substantially rectangular/square shape and typically having a hollow center area with various internal webbing 21 as best shown in FIGS. 2 and 4. It should be understood that the spacer members 20 may be any shape suitable to provide a center frame 18 having the proper support between the upper 14 and lower 16 decks. It should also be understood that the specific size and shape of the spacer members 20 may be modified as necessary and desired, and variations of the overall size and shape are within the scope of the present disclosure.

With reference to FIGS. 2 and 4, in various embodiments, a reinforcement support structure 28 is provided and is disposed between the center frame 18 and the lower deck 16. Such a reinforcement support structure 28 is provided for additional strength and to minimize deflection of the pallet 10 in use. By way of example, the reinforcement support structure 28 may include a plurality of metal crossbars 30 or elongated rods formed from high strength materials, such as steel, composites, metals, thermoset materials, and mixtures thereof. In certain embodiments, the reinforcement support structure 28 includes a square or rectangular shaped outer perimeter and at least one supporting crossbar extending across the center area of the pallet. The reinforcement structure may be formed having an “I” beam type cross-sectional area and may be formed using pultrusion techniques. The crossbars 30 may be joined together using welding techniques or via other mechanical interlocking techniques. For example, it is envisioned that interlocking techniques reminiscent of “Lincoln log” building sets may be used. As such, the reinforcement support structure 28 may be configured wherein each portion or segment 30 interlocks with a neighboring portion or segment 30 in pre-cut areas on the ends thereof, or at their centers. In certain embodiments, the segments 30 may be crimped to one another.

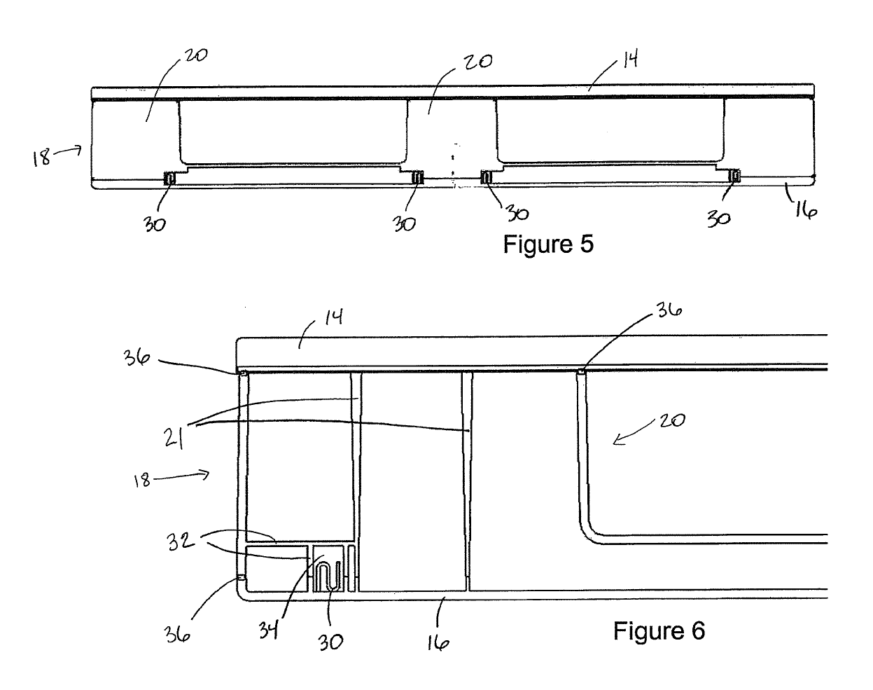

FIG. 5 illustrates a cross-sectional view of the pallet of FIG. 1 taken along the line 5-5. FIG. 6 is a partial cross-sectional view of the pallet of FIG. 1 taken along the line 6-6. In certain embodiments, and as shown in FIG. 5, the reinforcement support structure 28 may include a plurality of metal crossbars 30 having an “S” shape vertical cross section. In certain other embodiments, themoset materials could be shaped using pultrusion processes to form structures having other common geometrical shapes operable to serve as a reinforcing member for a support structure, such as rectangular, triangular, or polygonal. Still further, thin gauge cold formed steel may also be used.

At least one or both of the center frame 18 and lower deck 16 may be molded and provided with a network of integral ribs 32 forming various channels 34 that are configured to receive at least a portion of the reinforcement support structure 28. As best shown in FIGS. 4-6, the reinforcement support structure 28 is sandwiched between the center frame 18 and the lower deck 16. In certain embodiments, it may be fully enclosed within the pallet 10 and is not accessible from an exterior thereof.

The term “structural foam molded thermoplastic resin”, as used herein, refers to plastics or pallet components that are manufactured or obtained using structural foam molding techniques. As known in the art, structural foam molding is a comparatively low pressure method of processing certain thermoplastic materials and typically produces components having integral external skins, a cellular type core, and a high strength-to-weight ratio such that the component can be used in various load-bearing applications. Resins may be selected depending on the specific pallet design, load capacity, and other requirements. It is contemplated that the rackable pallet of the present invention may be formed from thermoplastic resin selected from the group consisting of HDPE (high density polyethylene), ABS (acrylonitrile butadiene styrene), PPO (polyphenylene oxide), PPE (polyphenylene ether), nylon, and mixtures thereof. Alternatively, other resins compatible with structural foam molding manufacturing can be used. Structural foam molding produces moderately rigid parts with a relatively hard surface, suitable for pallet use. Unlike common injection molding that utilizes high pressures to force a molten polymer to fill up the cavity of the mold, the structural foam molding process of the present disclosure provides a low pressure molding alternative may rely on the foaming action caused by an inert gas distributed in the resin to facilitate the flow. Alternatively, foaming can also be created by gases that are released by the decomposition of a chemical blowing agent that may be optionally added to the resin. Structurally foam molding generally provides thick wall sections and allows the molten resin to flow further than the typical injection molding processes would allow, and with lower pressure. Structural foam molding also allows the benefit of using softer and lighter tool grade steels and the molds may be machined faster in addition to being less difficult to handle and not as time consuming to make.

Optional non-limiting additives for the resin material may include colorants, UV protectors, flame and fire retardant fillers (including, for example, halogenated or non-halogenated intumescents), lubricants, soaps, various inert fillers, reinforcements (including, for example, natural, synthetic, and glass fibers), polymerization initiators, coupling agents, and other additives known in the art that are suitable for the structural foam molding process. Foaming agents used in the structural foam molding process may include compressed inert gas, such as nitrogen, or the foaming action may be supplied by chemical reaction as is known in the art.

In various embodiments, the materials used in the manufacture of pallet components may include at least one recycled thermoplastic resin component. The materials selected for use in the pallet preferably have excellent resistance to chemicals, including strong solvents, and are not moisture or odor absorbent. Any components containing recycled materials according to the present disclosure are robust and rugged in construction, configured to withstand the weight of goods stacked on them and to withstand the impact of truck forks driven into them as a result of misalignment.

The rackable pallet of the present disclosure may be made with one or more components formed from a plastic material other than those that are formed via structural foam molding process. As used herein, “plastic material” includes, but is not limited to, plastic materials suitable for use as a high strength component for a pallet, such as thermoplastic polymers resistant to many chemical solvents, bases and acids, for example, polypropylene, polyethylene, polyurethane, polyvinylchloride, and poly(ethylene terephthalate). The plastic material may also include various types and grades of nylon, such as nylon 6, and nylon 6, 6, and recycled nylon including that obtained from many industrial type sources, for example from automotive uses, such as nylon gears; rubber textiles; and rubber fabrics. The plastic may be selected depending on the specific pallet design, load capacity, and other requirements. In various embodiments, the components of the pallet may be manufactured with either recycled components alone or combination with at least one prime or virgin material. Thus components of the rackable pallet may include various grades of virgin plastic, recycled plastic, and mixtures thereof.

The above-referenced plastic materials may also include reinforcing fibers. Reinforcing fibers that may be used according to the present disclosure include inorganic fibers, more preferably the fibers include glass fibers. The fibers include both individual fibers or rolls of fiberglass mats, or veils. One common fiber mat is woven roving material. The woven roving material may contain various grades of bidirectional, or weaved, organic and/or inorganic fibers. As used herein, the general term “fiber” refers to individual filaments, fibers and fiber bundles. Both individual fibers and fiber bundles can have a substantially greater width as well as height as compared to the individual filaments or fibers. Preferably, the woven roving comprises one of a high-strength fiber, a high-strength fiber in a polymer composite matrix, a high-strength fiber in a metal matrix, a high-strength metallic band, and a high-strength metallic wire.

Some non-limiting examples of inorganic fibers include E glass, S glass, high silica fibers, quartz, boron, silicon carbide, silicon nitride, alumina, and titanium carbide. Other materials for the woven roving layer include any and all pitch- and polyacrylonitrile (PAN)-based carbon fibers including standard modulus grades, intermediate modulus grades, high modulus grades, and ultra-high modulus grades. Additional materials for the woven roving layer include any and all grades of aramid, meta-aramid, and para-aramid fiber. Also, any and all grades of metallic banding, wire, or fiber, including steel alloys, aluminum alloys, and titanium alloys may be used.

Where the woven roving includes a composite material, the binding matrix may include any and all grades of thermosetting and thermoplastic polymers. Some examples include epoxy, polyester, vinyl ester, polyurethane, silicone, butyl rubber, phenolic, polyimide, bismaleimide, cyanate ester, polyetheretherketone, polyphenylenesulfide, polysulfone, polyethylene, polypropylene, polycarbonate, polyetherimide, polyethylenesulfide, acrylic, acylonitrile butadiene styrene, and nylon.

Various embodiments of the present disclosure may incorporate the use of high tensile strength filaments, such as glass, in the form of a woven roving material mixed in the resin, if practicable, or as an additional layer provided on a pallet component. The fibers may be woven in a bidirectional pattern with untwisted roving strands, drawn in a substantially parallel orientation. Typical lengths of the continuous fibers may have a range of about 40 to about 48 inches, corresponding to the length and width of the pallet, respectively.

The manufacture of the upper deck 14, the lower deck 16, and the center frame 18 sections of the present disclosure into various shapes and patterns for use in forming a pallet is preferably achieved using structural foam molding methods and techniques using various resin materials. According to the methods of the present disclosure, after the requisite components are formed from structural foam molded thermoplastic resin, they are assembled into a pallet 10. As discussed above in more detail, in one embodiment, the resin material is shaped and manufactured having a board or panel geometry suitable for use as an upper deck 14, while the center frame 18 and lower deck 16 may be provided with cross board type members. In one embodiment, the upper deck 14 is manufactured having a upper and lower sheets that are vibration welded or otherwise joined to one another, thereby forming a hollow member. The reinforcement support structure 30 is preferably disposed between the center frame 18 and the lower deck 16. At least one or both of the center frame 18 and lower deck 16 may be provided with a network of integral ribs 32 that cooperate with one another to form one or more partial or complete channels 34 extending throughout the lengths of the sides 12, operable to receive the reinforcement support structure 30. Once the reinforcement support structure is aligned in place, the center frame 18 may be joined to the lower deck 16 by any suitable method for attaching two plastic components to one another. By way of example, FIG. 6 illustrates a plurality of suitable weld joints 36. In certain embodiments, the reinforcement support structure 30 is provided in a manner such that it is fully enclosed, or encapsulated between the center frame 18 and lower deck 16 of the pallet 10 and is not accessible from an exterior of the pallet. The upper deck 14 is then joined to the center frame 18 via the plurality of support members 20. As discussed above, the separate structural foam molded pallet components may be joined to one another via vibration welding, infrared welding, hot plate welding, and other welding or fusing techniques. For example, neighboring or adjacent structural foam molded components may be provided each having a network of integral ribs and channels, wherein the respective ribs of the two molded components are configured to be fused to one another

Rackable pallets made according to the present invention typically weigh less than 50 lbs, which is 30% lighter that the typical multi-use wooden pallet. Such a 25% weight savings provides pallets that are easier to handle and saves tremendous fuel and transportation costs.

What is claimed is:

1. A rackable pallet comprising:
an upper deck;
a lower deck; and
a center frame connecting the upper and lower decks together to form a pallet,
wherein at least one of the upper deck, lower deck, and center frame comprises a structural foam molded thermoplastic resin.

2. A rackable pallet according to claim 1, wherein the center frame comprises a plurality of spacer members separating the upper deck and lower deck and defining a plurality of apertures therebetween.

3. A rackable pallet according to claim 1, wherein the center frame is a monolithic member comprising a plurality of integrally extending cross members connecting the spacer members.

4. A rackable pallet according to claim 1, further comprising a reinforcement support structure disposed between the center frame and lower deck.

5. A rackable pallet according to claim 4, wherein the reinforcement support structure comprises a plurality of metal crossbars.

6. A rackable pallet according to claim 5, wherein the metal crossbars are joined together via a welding technique.

7. A rackable pallet according to claim 4, wherein the reinforcement support structure comprises a plurality of crossbars joined together via a mechanical interlocking technique.

8. A rackable pallet according to claim 4, wherein the reinforcement support structure comprises an “S” shape vertical cross-section.

9. A rackable pallet according to claim 4, wherein at least one of the center frame and the lower deck comprises a network of integral ribs and channels configured to receive the reinforcement support structure.

10. A rackable pallet according to claim 4, wherein the reinforcement support structure is fully enclosed within the pallet and is not accessible from an exterior of the pallet.

11. A rackable pallet according to claim 4, wherein the reinforcement support structure comprises a rectangular shaped outer perimeter and at least one supporting crossbar extending across a center of the pallet.

12. A rackable pallet according to claim 1, wherein the upper deck comprises two structural foam molded components each having a network of integral ribs and channels, wherein the respective ribs of the two molded components are configured to be fused to one another.

13. A rackable pallet according to claim 1, wherein the structural foam molded thermoplastic resin comprises at least one material selected from the group consisting of HDPE, ABS, PPO, PPE, nylon, and mixtures thereof.

14. A rackable pallet according to claim 1, wherein the structural foam molded thermoplastic resin comprises at least one fire retardant filler and UV stabilizer.

15. A rackable pallet according to claim 1, wherein the upper deck, the lower deck, and the center frame are fastened together using plastic welding techniques to form the rackable pallet.

16. A method of manufacturing a rackable pallet assembly, the method comprising:
forming an upper deck, a lower deck, and center frame from a structural foam molded thermoplastic resin; and
joining the upper deck, the center frame, and the lower deck to form a rackable pallet.

17. A method according to claim 16, wherein forming the upper deck comprises joining an upper sheet and a lower sheet together using vibration welding techniques.

18. A method according to claim 16, wherein forming the lower deck and the center frame comprises providing a network of integral ribs and channels, and joining the lower deck and the center frame comprises fusing the respective networks of integral ribs with one another.

19. A method according to claim 18, further comprising providing a reinforcement support structure disposed between the center frame and the lower deck.

20. A method according to claim 16, wherein structural foam molded thermoplastic resin comprises at least one material selected from the group consisting of HDPE, ABS, PPO, PPE, nylon, and resin mixtures thereof and the foaming agent comprises nitrogen.
